(19) United States
(12) Patent Application Publication
(10) Pub. No.: US 2006/0011477 A1
(43) Pub. Date: Jan. 19, 2006

(54) Sensors

(75) Inventors: William Charles Maskell, London (GB); Deepak Jawahurlall Gopaul, London (GB)

Correspondence Address: Anthony R Barkume, 20 Gateway Lane, Manorville, NY, 11949, US

(73) Assignee: Sensox Limited, Middlesex (GB)

(21) Appl. No.: 10/531,864

(22) PCT Filed: Oct. 20, 2003
(86) PCT No.: PCT/GB03/04518

§ 371 Date: Apr. 18, 2005

(30) Foreign Application Priority Data
Oct. 18, 2002 (GB) 0224267.5

(51) Int. Cl. G01N 27/26; H01S 4/00

(52) U.S. Cl. 204/424; 29/592.1

(57) ABSTRACT

In a zirconia oxygen sensor utilising a diffusion hole, the hole is made by inserting an organic fibre or element in the green ceramic and firing to destroy the fibre or element and leave a hole in its place. A package for a sensor is described in which the wire/posts for the electrical connections also form a cage to hold the sensor, heater(s) and thermal insulation firmly and plug into an electrical socket.

This invention relates to sensors based upon oxygen-ion-conducting ceramics including hafnia, zirconia and ceria.

The abbreviation OIC is used here for oxygen-ion conductor. The preferred type of OIC is zirconia which may be of the crystalline forms tetragonal, partially-stabilised or cubic. The preferred crystalline type is cubic. Zirconia is the generic term for zirconium dioxide (four-valent) the crystal structure of which has been stabilised with any of various three- or two-valent oxides such as yttria, erbia, gadolinia, calcia, magnesia and others; the preferred stabiliser is yttria. The sensors are normally referred to as zirconia sensors, although here this includes sensors based upon the other 4-valent oxides used in OICs. Zirconia sensors are used for the detection of oxygen, carbon dioxide, water vapour, etc.

Zirconia is an oxygen-ion conductor at elevated temperatures (>300° C.) and its conductivity increases as the temperature is raised. Thus, by applying porous electronically-conducting electrodes, such as platinum, to the two surfaces of a disc of the ceramic and imposing a voltage between the electrodes, a current flows and oxygen is electrochemically pumped through the zirconia (amperometric mode); or, if the disc is in contact with gases having different oxygen partial pressures at each electrode then the system is a concentration cell and a Nernst EMF is generated between the two electrodes (potentiometric mode).

Amperometric (two-electrode) zirconia sensors are solid state electrochemical devices that have been developed and used principally for measuring oxygen in gas mixtures. Work has been reported where use has been extended to include measurement of water vapour or carbon dioxide. Adding a further pair of electrodes to the sensor enables it to be operated as a pump-gauge device which can still be used in the amperometric mode while providing additional information for analytical purposes via the gauge.

Amperometric zirconia sensors normally have a single enclosed internal volume and hence may be termed single-chamber devices. Some zirconia sensors have two enclosed internal volumes which may or may not be connected to each other and to the external environment via a hole or holes and may be termed double-chamber devices; the inclusion of the second chamber confers additional benefits and this invention encompasses sensors with one, two or more chambers.

Thick-film amperometric oxygen sensors have been constructed using an ink prepared from a powder of yttria-stabilized zirconia; the construction consists of layers of electrode (cathode), zirconia, electrode (anode) printed onto a substrate. The zirconia performs the dual role of diffusion barrier (by virtue of its porosity) and electrolyte. These sensors display characteristics typical of an amperometric sensor. Preparation techniques for the sensor involve high temperatures, e.g. of the order of 1450° C. and elevated operating temperatures, e.g. of the order of 700° C.

One type of zirconia sensor comprises a hollow cylinder closed at both ends, one end of which comprises a disc of zirconia, which disc has gas permeable electrodes on either side. The cylinder has a diffusion hole or holes formed within the structure connecting the inner volume of the hollow cylinder with the surrounding gas.

In use the sensor is heated and a potential difference, with appropriate polarity, is applied across the disc via one pair of the electrodes; when a gas containing oxygen enters through the diffusion hole(s) the current flowing is a measure of the oxygen concentration in the gas surrounding the sensor.

Hitherto the sensor has been made by forming the sensor from a green (i.e. unfired) zirconia ceramic (formed from an intimate mixture of zirconia powder with a binder), for example by assembling discs and rings of the green zirconia ceramic to form the desired shape, inserting wires of e.g. platinum, to form electrical connections to the electrodes, printing, painting or otherwise applying the electrodes onto the green zirconia ceramic, inserting and then removing a metal wire in the green zirconia ceramic to form the diffusion hole and firing the structure.

The hole formed is adversely affected both by the pulling out of the wire and by the subsequent relaxation of the material surrounding the hole, which can result in an imprecise and not well-defined hole. This affects the accuracy and repeatability of the results from sensor to sensor.

We have now devised an improved method of forming the diffusion hole or holes which also enables holes with simple or complex geometries to be engineered.

According to the invention there is provided a method of forming a diffusion hole in a fired ceramic which method comprises forming a green ceramic structure from an intimate mixture of a powder of the ceramic and a binder, which is normally a polymer, which structure incorporates an organic fibre or fibres or other organic element or elements with a uniform or non-uniform cross-section passing from one side of the ceramic structure to the other in a straight or non-straight path, firing the green ceramic structure at an elevated temperature to sinter the ceramic and to destroy the binder and the organic fibre(s) or organic element(s).

The preferred ceramic is an OIC such as hafnia, zirconia or ceria.

For sensors, where the organic element is a fibre or fibres of uniform circular cross-section, the diameter of the hole(s) after firing is preferably greater than 10 microns and more preferably in the range 25 to 200 microns and the size of the fibre(s) chosen accordingly. For zirconia ceramics there is normally a linear size reduction of about 20% on firing and this is allowed for in the dimensions of the green ceramic and fibre(s) or other organic elements used.

The fibre can be destroyed by one or more of vaporisation, carbonisation, combustion or any other process which destroys and so removes the organic fibre.

The green ceramic can be formed by conventional methods, such as by forming an intimate mixture of zirconia powder with a binder such as a polymer and a solvent for the polymer and forming into a sheet or tape. Preferably the polymer is water-soluble or water-swellable and the solvent is water. Discs and rings of this material are readily punched out from such a tape using simple steel tools.

The green structure can be fired in a conventional furnace to form a hard ceramic material and temperatures over 1000° C., e.g. 1450° C., are typically used. During the process of heating up to this temperature, the binder and the organic fibre are vaporised or otherwise destroyed.

The invention also provides a sensor which comprises a hollow cylinder with at least part of one end being formed of a disc of an oxygen-ion conducting ceramic such as zirconia, which disc has gas permeable electrodes on either side of it, and the cylinder, including any end caps, has at least part of its structure formed of a ceramic with at least one diffusion hole formed through it by the method described above, the diffusion hole connecting the inner volume of the hollow cylinder with the surrounding atmosphere.

Preferably the cylinder is formed of an oxygen-ion conducting ceramic such as zirconia, i.e. the walls and ends of the cylinder are formed of an oxygen-ion conducting ceramic such as zirconia with a diffusion hole through an end or side of the cylinder.

The disc of an oxygen-ion conducting ceramic can be of any shape, e.g. circular, rectangular, square, elliptical etc.

The cylinder will normally have a circular cross section, but the cross section can be of any shape, e.g. rectangular, square, elliptical etc.

Preferably at least an electrode on the inside of the cylinder is porous so that oxygen can diffuse through the electrode to the three phase boundary, electrode-gas-electrolyte (where the electrolyte is an OIC such as for example zirconia). Preferably the electrodes are made of a porous platinum or a porous platinum-cermet where the ceramic in the cermet preferably has the same composition as that used for the electrolyte.

The sensor also includes a heating element to raise the temperature of the sensor to the desired operating temperature, e.g. of the order of 350-800° C. The heating element can be in the form of resistance wires in contact with, embedded in or adjacent to the ceramic disc and an electric current can be fed to the heating element by means of platinum or other metal wires. Preferably, the heating element is in the form of a metal layer or layers on the surface of a substrate or substrates and an electric current can be fed to the heating element by means of platinum or other metal wires.

A preferred structure is for the heating element to be in the form of a circular or square disc, which may be made of alumina, onto which is applied a metal film to carry the electrical current, in contact with, or adjacent to the sensor element structure; more preferably there can be two heating elements, one on either side of the sensor element to form a sandwich construction and this arrangement then provides more uniform heating of the sensor. A preferred metal for the metal film is platinum and a preferred process for applying the metal film to the substrate is screen-printing. The heating elements can be connected in series or parallel; if they are in parallel there is still heating if one heating element should fail.

In use, the current flowing between the electrodes can be monitored and this used as a measure of oxygen concentration. Alternatively a constant current can be passed through the disc and the voltage monitored or the electrodes on the disc are on open-circuit and a voltage measured between said electrodes.

The invention also provides a method of making a sensor incorporating a sensor element which comprises (i) placing the sensor element on a support disc having a number of electrically isolated conductive wires/posts passing through and fixed to it, the wires/posts being positioned in a substantially circular configuration of diameter larger than the dimensions of the sensor element, with the sensor element positioned within the circle formed by the wires/posts and (ii) passing the wire/posts up the sides of the sensor element to grip the sensor element and (iii) connecting the wire/posts to electrical contacts for electrodes and for a heating element.

A preferred method of making a sensor incorporating a sensor element, which may be a cylindrical sensor element or a planar sensor element or a sensor element of some other geometry, comprises placing the sensor element, plus heaters and thermal insulation where appropriate, on a support disc having a number of electrically isolated conductive wires/posts passing through and fixed to it. The wires/posts are positioned in a substantially circular configuration of diameter larger than the diameter of the sensor element with the cylindrical or planar sensor element (including heaters and thermal insulation where appropriate) positioned within the circle formed by the wires/posts so that the wires/posts pass up the sides of the sensor element to grip the sensor element and connect to the contacts for the electrodes and for the heating elements. The wires/posts are normally then bent over at the ends to grip and hold the sensor element. In this case, where thermal insulation is used, there is normally a layer of thermal insulation situated between the support disc and the sensor element or between the support disc and the sensor element/heater combination.

In a further preferred embodiment, the electrically isolated conductive wires/posts pass through the support disc in a substantially circular configuration; they are bent at right angles outwards (or inwards) in a radial configuration, then bent a second time at a point further along the wires/posts so that the conductive wires/posts are again running essentially parallel to each other and perpendicular to the support disc but now in a substantially circular configuration (of diameter larger than the diameter of the sensor element) which is of larger (or smaller) diameter than that at the point where the wires/posts traverse the support disc. The sensor, heater(s) and thermal insulation material are then introduced into the region between the support disc and the wires/posts as above. In this case the sensor element-heater element-thermal insulation combination may not be in contact with the support disc being supported instead on the platform formed by bending the wires.

In a further embodiment, the isolated conductive wires/posts pass through the support disc in a non-circular configuration; they are bent on at least one side of the support disc/posts so that the conductive wires/posts run essentially parallel to each other and perpendicular to the support disc but now in a substantially circular configuration. The sensor, heater(s) and thermal insulation material are then introduced into the region between the support disc and the wires/posts as above. As in the previous case the sensor element-heater element-thermal insulation combination may not be in contact with the support disc being supported instead on the platform formed by bending the wires.

In a further preferred embodiment, the thermal insulation is cut as discs from sheet materials and is added in layers during assembly to fit within the circular arrangement of wires/posts. Alternatively, some or all of the discs of thermal insulation material may be cut so as to extend beyond the diameter of the circular arrangement of wires/posts; in this case, either the wires/posts pass through the outer edges of such discs or the outer edges of some or all of the discs have a pattern cut in the circumference such that the wires/posts fit into the indentation generated. In each of these options each disc has a uniform thickness, but thickness may vary from disc to disc.

At the level where a heater(s) and sensor are added, a hole may be cut in the accompanying layer or layers of insulation material so that the insulation material surrounds the active components and fills the gap between the heater or sensor and the wires/posts.

Each heater has two wires which are typically platinum connected to it to supply electrical power to the heating element. The sensor has at least two wires, which are normally platinum, ruing to it with each wire connected to at least one of the sensor electrodes. The wires from the heaters and from the sensor run between the layers of thermal insulation and are connected to the wires/posts running through the support disc. It is to be noted that, with the method of packaging described, the sensor and heaters are not supported by the attaching wires and hence the diameters of the wires may be chosen on criteria other than mechanical strength, e.g. cost. A further benefit of this method of packaging is improved vibration and shock resistance of the sensor/heater(s).

The ends of the wires/posts on the other side of the support disc from the sensor can be connected to an appropriate electricity supply, e.g. for measuring the current flowing through the ceramic and for heating the element. If a standard PCB (printed circuit board) socket is used, the ends of the wires/posts on the other side of the support disc from the sensor can be plugged into the socket mounted on a standard board.

This structure is easy to fabricate and robust and easy to use.

The invention is illustrated in the drawings in which:—

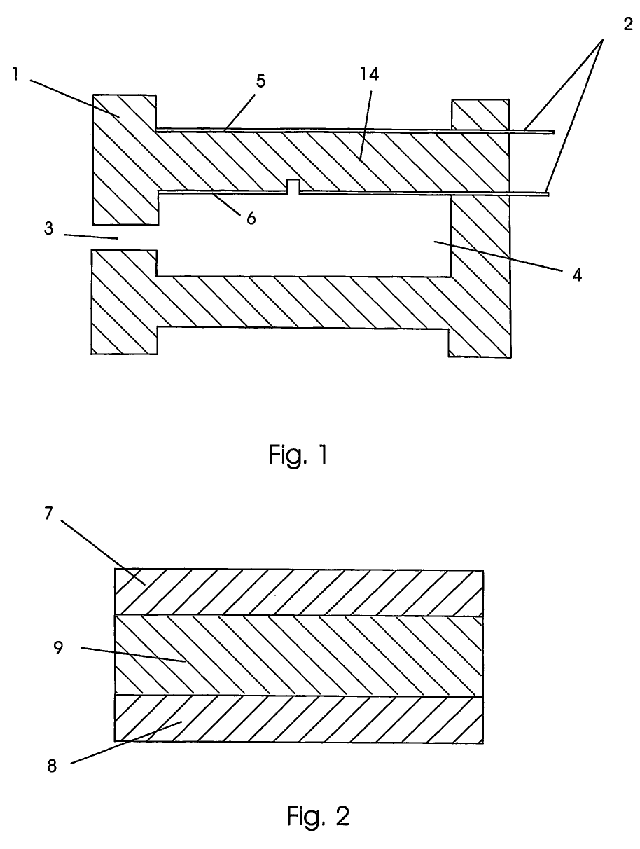

FIG. 1 shows a cross section of a sensor element;

FIG. 2 shows a cross section of an assembled sensor and

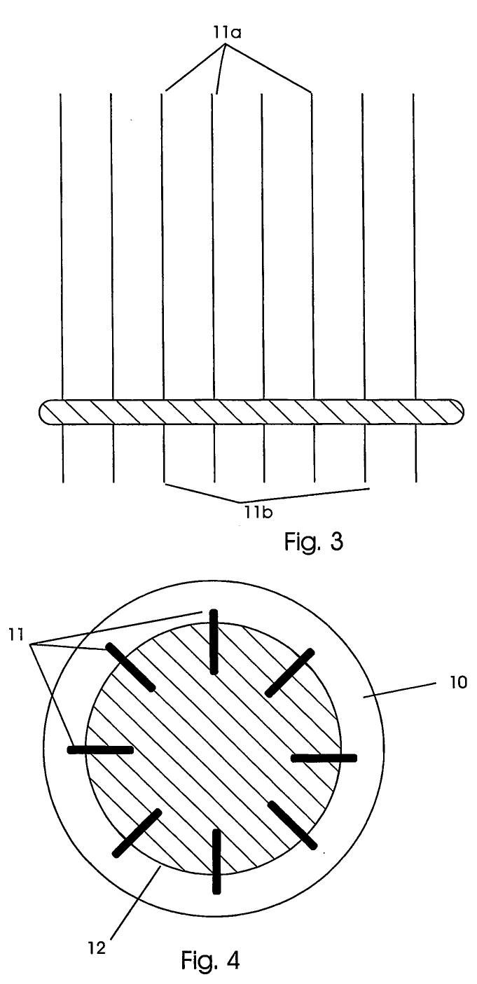

FIGS. 3 and 4 show a preferred construction of a sensor.

Referring to FIG. 1 the sensor element is formed of a fired zirconia ceramic cylinder (1) which has an internal cavity (4), and a diffusion hole (3) formed in it. There are platinum electrodes (5) and (6) either side of the end (14) of the zirconia cylinder (1). The platinum electrodes are connected to wires (2).

The sensor element was formed from a green yttria-stabilized cubic zirconia with a water-soluble or water-swellable binder and water; there was an organic fibre passing through one end/side. The structure was fired at 1450° C. and the organic fibre and the binder were destroyed by the high temperature, the zirconia powder sintered and the structure of FIG. 1 formed. Platinum wires (2) which contact electrodes on the sensor were included as in conventional sensors. There is an electrical heating element (shown in FIG. 2) which heats up the sensor to operating temperature.

In use, a potential difference of appropriate polarity is applied between wires (2) and, when a gas containing oxygen diffuses through the hole (3), the current flowing between the wires (2) is a measure of the oxygen concentration.

Referring to FIG. 2 the assembled sensor comprises a sensor element (9) as in FIG. 1 on either side of which are heater elements (7) and (8).

Referring to FIG. 3, this shows the support for the assembled sensor and comprises a solid disc (10) into which wires (11a) are fixed and the ends (11b) are arranged to plug into a socket. To assemble the sensor element the sensor, including heaters and thermal insulation material, is placed within the circle formed by the wires (FIG. 4) and the wires (11) are bent over the top of the sensor to grip and hold the sensor. All or some of the wires (11) are connected to the various components of the sensor so that a voltage may be applied to the electrodes of the sensor element and the current flowing in the sensor element can be measured and the heating elements operated.

1-42. (canceled)

43. A method of forming a diffusion hole in a fired ceramic which method comprises (i) forming a green ceramic structure from an intimate mixture of a powder of the ceramic and a binder, which structure incorporates at least one organic fibre or other organic element passing from one side of the ceramic structure to the other in a straight or non-straight path and (ii) firing the green ceramic structure at an elevated temperature to cure the ceramic and to destroy the binder and the organic fibre or other organic element.

44. A method according to claim 43 in which the binder is a water-soluble or water-swellable polymer.

45. A method according to claim 43 in which, where a fibre is employed, the diameter of the hole after firing is greater than 10 microns.

46. A method according to claim 43 in which, where a fibre is employed, the diameter of the hole after firing is in the range 25 to 200 microns.

47. A method according to claim 43 in which the green structure is fired at a temperature in excess of 1000° C.

48. A method according to claim 43 in which the ceramic is an oxygen-ion conductor.

49. A method according to claim 48 in which the oxygen-ion conductor is a 4-valent metal oxide stabilised with a three- or two-valent metal oxide.

50. A method according to claim 48 in which the 4-valent metal oxide is selected from zirconium dioxide, cerium dioxide and hafnium dioxide.

51. A method according to claim 49 in which the 3-valent metal oxide is yttria.

52. A method according to claim 50 in which the oxygen-ion conductor is zirconium dioxide stabilised with yttria.

53. A method according to claim 49 in which the crystalline form of the oxygen-ion-conducting ceramic is cubic.

54. A sensor which comprises a hollow cylinder with end caps enclosing an internal volume, one end of the cylinder being a sensor element comprising a disc of oxygen-ion-conducting ceramic having a porous electrode positioned at least on its internal surface and the cylinder having at least part of its structure formed of a ceramic with at least one diffusion hole formed in its structure by the method of claim 1, there being an electrical heating element able to heat the disc of oxygen-ion-conducting ceramic.

55. A sensor which comprises a hollow cylinder with end and intermediate caps enclosing at least two internal volumes, the cylinder having at least part of its structure formed of a ceramic which has one or more holes formed in its structure by the method of claim 1, one end of the cylinder being a sensor element comprising an oxygen-ion-conducting disc which has a porous electrode positioned on each surface, there being an electrical heating element able to heat the oxygen-ion-conducting disc.

56. A sensor according to claim 54 in which the cylinder is formed of an oxygen-ion-conducting ceramic with a diffusion hole through an end or side of the cylinder.

57. A sensor according to claim 54 in which the electrodes are made of a porous platinum or a porous platinum/oxygen-ion-conductor cermet.

58. A sensor according to claim 57 in which the oxygen-ion-conductor in the cermet is of the same composition as that used in the green ceramic to form the electrolyte of the sensor element.

59. A sensor according to claim 54 in which the heating element is in the form of resistance wires in contact with, embedded in or adjacent to the disc of oxygen-ion-conducting ceramic and an electric current can be fed to the heating element by means of platinum or other metal wires.

60. A sensor according to claim 54 in which the heating element is a circular or square ceramic disc onto which is printed a metal film to carry the electrical current, in contact with, or adjacent to the disc of oxygen-ion-conducting ceramic or the sensor element.

61. A sensor according to claim 54 in which the heating element is a circular or square alumina disc onto which is printed a metal film to carry the electrical current, in contact with, or adjacent to the sensor element.

62. A sensor according to claim 54 in which there are two heating elements, one on either side of the sensor element, to form a sandwich construction and in which the heating elements are connected in series or parallel.

63. A sensor according to claim 54 in which a constant current can be passed through the ceramic disc via porous electrodes on each side of said disc and a voltage monitored.

64. A sensor according to claim 54 in which the electrodes on the ceramic disc are on open-circuit and a voltage measured between said electrodes.

65. A method of making a sensor incorporating a sensor element which method comprises (i) placing the sensor element on or adjacent to a support disc having a number of electrically isolated conductive wires/posts passing through and fixed to it, the wires/posts being positioned in a substantially circular configuration of diameter larger than the dimensions of the sensor element with the sensor element positioned within the circle formed by the wires/posts and (ii) passing the wire/posts up the sides of the sensor element to grip the sensor element and (iii) connecting the wire/posts to electrical contacts for electrodes and for a heating element.

66. A method of making a sensor as claimed in claim 65 incorporating a sensor element which method comprises (i) placing the sensor element on or adjacent to a support disc having a number of electrically isolated conductive wires/posts passing through and fixed to it in a non-circular configuration, the wires/posts being bent into a substantially circular configuration on the side of the support disc used to incorporate the sensor element and of diameter larger than the dimensions of the sensor element with the sensor element positioned within the circle formed by the wires/posts and (ii) passing the wire/posts up the sides of the sensor element to grip the sensor element and (iii) connecting the wire/posts to electrical contacts for electrodes and for a heating element.

67. A method of making a sensor according to claim 66 in which the sensor element is placed on thermal insulating material and there is at least one heating element in contact with adjacent to or forming part of the sensor element.
